(19) United States
(12) Patent Application Publication
(10) Pub. No.: US 2008/0103043 A1
(43) Pub. Date: May 1, 2008

(54) Thermal Transfer Receiving Sheet

(75) Inventors: Kyoko Uchida, Tokyo (JP); Toshikazu Onishi, Tokyo (JP); Toru Nakai, Tokyo (JP); Yoshimasa Tanaka, Tokyo (JP); Yoshihiro Shimizu, Tokyo (JP); Masato Kawamura, Tokyo (JP)

Correspondence Address: KRATZ, QUINTOS & HANSON, LLP, 1420 K Street, N.W., Suite 400, WASHINGTON, DC, 20005, US

(73) Assignee: OJI PAPER CO., LTD., Tokyo (JP)

(21) Appl. No.: 11/663,475

(22) PCT Filed: Oct. 5, 2005
(86) PCT No.: PCT/JP05/18729

§ 371 Date: Mar. 22, 2007

(30) Foreign Application Priority Data
Oct. 6, 2004 (JP) 2004-294216
Nov. 26, 2004 (JP) 2004-343092

(51) Int. Cl. B41M 5/382

(52) U.S. Cl. 503/227

(57) ABSTRACT

A thermal transfer receiving sheet comprising: the sequential formation of an intermediate layer containing hollow particles and an image receiving layer on at least one side of a sheet-form substrate; wherein, the mean particle diameter of the hollow particles is 0.2 to 30 μm, the volumetric hollow rate is 40 to 95%, the printing smoothness (Rp value) of the surface of the image receiving layer as determined 10 msec after the start of pressurization at a printing pressure of 0.1 MPa using a microtopograph is 1.5 μm or less, and the 20° gloss in accordance with JIS Z 8741 is 80 or less.

### TECHNICAL FIELD

The present invention relates to a thermal transfer receiving sheet (also simply referred to as a “receiving sheet”) that forms an image by superimposing a thermal transfer sheet (ink ribbon) and thermally transferring a dye of the ink ribbon. More particularly, the present invention relates to a receiving sheet suitable for thermal dye transfer printers in particular, having an intermediate layer containing hollow particles between a sheet-form substrate and an image receiving layer.

### BACKGROUND ART

Thermal printers have attracted attention in recent years, and thermal dye transfer printers capable of printing clear, full-color images have attracted considerable attention in particular. Thermal dye transfer printers form images by superimposing a dye layer containing a dye of an ink ribbon and an image receiving layer (also referred simply referred to as a “receiving layer”) containing a dye-dyeable resin of a receiving sheet, and transferring the dye at a predetermined location of the dye layer onto the receiving layer at a predetermined density using heat supplied from a thermal head and so forth. The ink ribbon consists of three sequential dye layer regions in the colors of yellow, magenta and cyan, or four sequential dye layer regions in the colors of yellow, magenta, cyan and black. Full-color images are obtained by repeatedly transferring each color of dye of the ink ribbon to the receiving sheet in order. Receiving sheets are typically provided in the form of single sheets in such thermal dye transfer printers.

Due to advances made in the field of computerized digital image processing technology, thermal dye transfer printing significantly improves the quality of recorded images and expands the market for thermal dye transfer printers. In addition, accompanying improvement of thermal head temperature control technology, printing systems are being required to provide increasingly faster speeds and higher sensitivity. Consequently, an important technical objective is how to efficiently utilize the amount of heat generated by thermal heads and other heating devices for image formation. In addition, in consideration of a growing preference for lower printer prices and simpler structures, reducing the printing pressure generated by the thermal head and extending the head service life are also becoming important technical issues. At present, printers capable of printing a single A6-size sheet within 30 seconds are available on the market, and the demand for higher printing speeds is expected to increase in the future.

In order to efficiently form high-quality, high-density images, although a receiving sheet provided with a receiving layer composed primarily of a dye-dyeable resin on a substrate is typically used, if a conventional film is used for the substrate material, even though the film has superior smoothness, due to the escape of heat from the thermal head into the base material, the recording sensitivity becomes inadequate, or due to the inadequate cushioning of the film, inadequate adhesion between the ink ribbon and the receiving sheet occurs and causes uneven density or the like.

In order to solve this problem, use of a substrate comprising a foamed film laminated on a paper or other core material layer (see, for example, Japanese Unexamined Patent Publication (Kokai) No. 61-197282, page 1), or a substrate comprising a biaxially oriented film composed mainly of a thermoplastic resin such as polyolefin resin and containing a void structure laminated on a paper or other core material layer (synthetic paper) (see, for example, Japanese Unexamined Patent Publication (Kokai) No. 62-198497, page 1), have been proposed for use as the substrate. Although receiving sheets using these substrates have superior smoothness, they also have shortcomings such as lacking the texture of paper and being expensive.

In addition, when paper is used as the substrate of a receiving sheet, recording sensitivity decreases in the same manner as a film, and although cushioning is slightly better than a film, unevenness tends to occur in printing density due to uneven adhesion between the ink ribbon and the receiving layer attributable to uneven fineness of the paper fibers. Therefore, a receiving sheet was developed in which an intermediate layer containing hollow particles is provided between the paper substrate and the receiving layer to improve transfer density (see, for example, Japanese Unexamined Patent Publication (Kokai) No. 63-87286, pages 1-2; Japanese Unexamined Patent Publication (Kokai) No. 1-27996, pages 1-3). Although this receiving sheet has improved sensitivity due to the effect of improving heat insulation and cushioning by the hollow particle-containing layer, irregularities tend to occur in the surface of the receiving sheet due to the effects of the hollow particles.

In order to improve on these surface irregularities of the receiving sheet, a receiving sheet has been proposed that has a specific surface roughness and gloss by defining the mean particle diameter and hollow rate of the hollow particles used in the intermediate layer (see, for example, Japanese Unexamined Patent Publication (Kokai) No. H9-99651, pages 1-5; Japanese Unexamined Patent Publication (Kokai) No. 2001-39043, pages 2-3). In addition, with respect to a receiving sheet comprising a resin layer containing a foamed layer and a receiving layer formed on a substrate sheet, a method of subjecting the foamed layer and/or the receiving layer to a smoothing treatment had been proposed (see, for example, Japanese Unexamined Patent Publication (Kokai) No. 6-210968, pages 2-4).

However, the value of surface roughness of the receiving layer as determined by conventional measurement methods does not sufficiently correlate with the actual image quality obtained by a thermal dye transfer printer. It is difficult to obtain satisfactory image quality particularly in the case of images obtained with high-speed printers using a low printing pressure in the manner of current printers.

In addition, adequately satisfactory gloss is also not obtained in the cases described above. Although the intermediate layer containing hollow particles has satisfactory cushioning, the surface of the receiving layer is susceptible to damage, and thus for example, when storing these receiving sheets by stacking them on each other, contact of the top surface of the receiving layer of one receiving sheet with the underside surface of another receiving sheet may result in microscratches partially on the surface of the receiving layer, causing uneven gloss at those locations, thereby causing the problem of decreased product quality in terms of appearance.

### DISCLOSURE OF THE INVENTION

In consideration of the circumstances as described above, an object of the present invention is to provide a thermal transfer receiving sheet having an intermediate layer containing hollow particles, which solves the aforementioned problems associated with conventional receiving sheets, that is, suitable for use in thermal dye transfer printers, and in particular, enables high-sensitivity and high-density recording, offers improved density unevenness and white spots, yields extremely high image quality, and is resistant to the occurrence of gloss unevenness caused by microscratches.

The present invention includes each of the inventions described below.

(1) A thermal transfer receiving sheet having laminated on at least one side of its sheet-form substrate, an intermediate layer and an image receiving layer in this order, wherein said intermediate layer comprises hollow particles, and the mean particle diameter of the hollow particles is 0.2 to 30 μm, the volumetric hollow rate is 40 to 95%, the printing smoothness (Rp value) of the surface of the image receiving layer as determined 10 msec after the start of pressurization at a printing pressure of 0.1 MPa using a microtopograph is 1.5 μm or less, and the 20° gloss in accordance with JIS Z 8741 is 80 or less.

### (2) The thermal transfer receiving sheet as described in (1) above, wherein the thickness of the intermediate layer is 20 to 90 μm.

### (3) The thermal transfer receiving sheet as described in (1) or (2) above, wherein the compressive elastic modulus of the thermal transfer receiving sheet in accordance with JIS K 7220 is 35 MPa or less.

### (4) The thermal transfer receiving sheet described in any of (1) to (3) above, wherein the surface of the image receiving layer is formed by pressing against a molded surface having a centerline average roughness (Ra) of 0.01 to 1.0 μm.

### (5) The thermal transfer receiving sheet described in (4) above, wherein the surface of the image receiving layer is formed by pressing against a molded surface at a pressure of 0.2 to 150 MPa.

### (6) The thermal transfer receiving sheet described in (1) or (2) above, wherein the intermediate layer contains hollow particles in which shells are formed from a polymer material having a glass transition temperature of 75° C. or higher.

The receiving sheet of the present invention is suitable for thermal dye transfer printers, enables high-sensitivity and high-density recording, improves on density unevenness and white spots, yields extremely high image quality, is resistance to the occurrence of gloss unevenness caused by microscratches, and has a superior appearance of white paper.

### BEST MODE FOR CARRYING OUT THE INVENTION

The following provides a more detailed explanation of the present invention by indicating preferable modes thereof.

In order to obtain images of high sensitivity and high image quality, it is necessary for the receiving sheet to adequately adhere to the ink ribbon during printing, deform according to the shape of the thermal head, and efficiently utilize the heat from the thermal head to form images. Thus, the receiving sheet is required to have a highly smooth surface at the printing pressure used during printing.

As a result of conducting extensive studies, it was determined in the present invention that by designing the printing smoothness (Rp) of the receiving sheet surface (receiving layer upper surface) to be 1.5 μm or less when measured 10 msec after the start of pressurization under conditions of a printing pressure of 0.1 MPa using a microtopograph, images having high sensitivity and high image quality are obtained. The Rp value is substantially 0.1 to 1.5 μm and preferably 0.1 to 1.0 μm. If the Rp value exceeds 1.5 μm, the surface of the receiving sheet may lack smoothness, which may result in inferior printing density and printing quality of the receiving sheet.

Furthermore, the printing smoothness (Rp) in the present invention is the result of measuring a physical property proportional to the average depth of depressions in the surface of a sample pressed onto a reference surface (prism), and the measurement principle has been described in the Collection of Papers of the Japan Society of Printing Science and Technology, Vol. 17, No. 3 (1978) or the 60th Spring Research Presentation Conference of the Japan Society of Printing Science and Technology (1978). On the other hand, in the papermaking industry, apparatuses that calculate smoothness from the amount of leaked air are frequently used to typically indicate the smoothness of paper, examples of which include a Beck smoothness meter, Oken-type smoothness meter and Smoothster smoothness meter. However, when considering printing with a printer, it was determined that printing smoothness (Rp) under specific conditions can favorably reproduce the contact state of the receiving sheet with the thermal head via the ink ribbon during actual printing.

When an image is formed by transferring a sublimation dye from an ink ribbon to the receiving layer of a receiving sheet, the pressure applied to the receiving sheet by the pushing pressure between the thermal head and platen roller of the printer is normally about 0.1 to 0.5 MPa, and the time during which thermal energy is applied from the thermal head is typically 10 msec or less, thus indicating that the smoothness of the receiving sheet, namely the contact ratio between the receiving sheet and thermal head under pressure is important, even in an extremely short time.

A specular reflection smoothness tester (also referred to as a Chapman smoothness tester) has conventionally been known as an apparatus for measuring the optical contact ratio between a glass surface and paper under pressure. Although this specular reflection smoothness tester is able to reproduce printing pressure during thermal transfer printing, since reading of measured values for contact ratio take several seconds from the start of pressurization at the least, requiring an extremely long period of time as compared with the duration during which thermal energy is applied during actual thermal transfer printing, it is difficult to reproduce an actual printing state.

On the other hand, printing smoothness (Rp) can be calculated by measuring the optical contact ratio between a prism surface and paper in as little as 10 msec after the start of pressurization, and as a result of investigating the relationship between Rp values calculated from this contact ratio and image quality, Rp values measured 10 msec after the start of applying pressure of 0.1 MPa on the receiving sheet to the prism were determined to demonstrate a high degree of correlation with image quality. In addition, examples of measuring instruments that can be used include a printing smoothness tester (microtopograph optical contact ratio measuring apparatus, Toyo Seiki Seisakusho).

In addition, in the present invention, it is important that the 20° gloss (gloss measured at an incident angle of 20°) of the surface of the receiving layer as measured in accordance with JIS Z 8741 is 80 or less, and preferably 30 to 70. Although the intermediate layer containing the hollow particles has satisfactory cushioning, the surface is typically susceptible to scratches, and if the gloss exceeds 80, scratches tend to become conspicuous. For example, in the case of storing receiving sheets by stacking them on each other, contact of the receiving layer of one receiving sheet with the underside of another receiving sheet may result in microscratches partially on the surface of the receiving layer, causing uneven gloss at those locations, thereby causing the problem of decreased product quality in terms of appearance. If the gloss of the surface of the receiving layer is less than 30, the image gloss of images printed with a thermal transfer printer may be inferior.

Furthermore, although there are also cases in which 60° gloss is used as the method for measuring gloss, this method is typically suited for measurement of products having a comparatively low gloss, while the 20° gloss is suited for products having high gloss. For example, in the case of the receiving sheet of the present invention, if the 20° gloss is about 20, the 60° gloss is about 70, and in the range of a 20° gloss of about 35 or more, the 60° gloss exceeds 80, thereby the value becomes plateau, resulting in decreased accuracy. Thus, in the present invention, the 20° gloss is suitable for comparing gloss among individual products.

Moreover, the compressive elastic modulus of the receiving sheet of the present invention as measured in accordance with JIS K 7220 is preferably 35 MPa or less and more preferably 3 to 30 MPa. If the compressive elastic modulus of the receiving sheet exceeds 35 MPa, image quality becomes poor, ribbon wrinkles occur in the images, and product quality decreases.

Since the compressive elastic modulus of the receiving sheet of the present invention is sufficiently low, the inside region of the receiving sheet is suitably deformed when the receiving sheet is interposed between the thermal head and platen roller through the ink ribbon during printing, thereby improving adhesion between the thermal head and receiving sheet, and allowing the obtaining of superior recording density and image quality.

In addition, although wrinkles are formed in the ink ribbon accompanying local thermal compression thereof due to the heat from the thermal head, since the compressive elastic modulus of the receiving sheet is sufficiently low, the receiving sheet is able to deform following the shape of the wrinkles formed in the ink ribbon, thereby preventing the shape of the wrinkles formed in the ink ribbon from being transferred to the image surface and allowing the demonstration of a satisfactory appearance thereof. However, in the case the compressive elastic modulus is excessively high, since the receiving sheet is unable to adequately deform according to the shape of the wrinkles, the shape of the wrinkles formed in the ink ribbon are transferred to the image surface, thereby resulting in a poor appearance.

The layer construction of the receiving sheet of the present invention comprises at least a sheet-form substrate, an intermediate layer and a receiving layer, and a detailed description of these layers is provided below.

(Sheet-Form Substrate)

Examples of materials suitably used for the sheet-form substrate used in the present invention include: (1) paper composed mainly of cellulose pulp such as woodfree paper (acid paper, neutral paper, etc.), mechanical paper, coated paper, art paper, glassine paper, cast-coated paper, laminated paper provided with a thermoplastic resin layer such as a polyolefin resin on at least one side thereof, synthetic resin-impregnated paper, emulsion-impregnated paper, synthetic rubber latex-impregnated paper, synthetic resin-containing paper, foamed paper containing thermally expandable particles or cardboard, or (2) plastic films composed mainly of thermoplastic resins such as polyethylene, polypropylene and other polyolefins, polyethylene terephthalate and other polyesters, polyamide, polyvinyl chloride or polystyrene, and porous stretched films (e.g., synthetic paper or porous polyester film) having a monolayer structure or multilayer structure in which voids have been formed by extracting a molten mixture incorporating a non-compatible resin and inorganic pigment in these resins followed by stretching, and compound films in which these films or these films and other films or paper and so forth are laminated and adhered.

Among the aforementioned sheet-form substrates, paper composed mainly of cellulose pulp is used preferably due to its low level of thermal contraction, satisfactory thermal insulation, satisfactory handling as receiving paper and low price.

The sheet-form substrate of the present invention may have a sequentially layered construction comprising a first base material layer on which the receiving layer is formed, a pressure-sensitive adhesive layer, a release agent layer and a second base material layer, and a sheet-form substrate having a so-called sticker, seal or label type of structure can naturally also be used.

The sheet-form substrate used in the present invention preferably has a thickness of 100 to 300 μm. Incidentally, if the thickness is less than 100 μm, the mechanical strength thereof becomes inadequate, the stiffness of receiving sheets obtained therefrom becomes low, repulsion of deformation becomes inadequate and curling of the receiving sheet occurring during printing may become unable to be prevented. In addition, if the thickness exceeds 300 μm, since the thickness of the resulting receiving sheet is excessively great, this may lead to a decrease in the number of receiving sheets capable of being housed in the printer, or if a predetermined number of receiving sheets is attempted to be housed therein, the size of the printer may have to be increased, thereby resulting in problems such as creating difficulty in making the printer more compact.

(Intermediate Layer)

In the present invention, an intermediate layer is formed on at least one side of the sheet-form substrate. Since this intermediate layer provides a high degree of cushioning as a result of its porous structure by having for its main component a binder resin and hollow particles, a highly sensitive receiving sheet is obtained even in the case of using paper for the sheet-form substrate. As a result of containing hollow particles in the intermediate layer, a suitable degree of freedom with respect to deformation is imparted to the receiving sheet, and since this improves the adhesion and the ability of the receiving sheet to follow the shape of the printer head and ink ribbon, thermal efficiency of the printer head relative to the receiving layer is improved even in a low energy state and thus printing density is enhanced, thereby improving image quality. In addition, printing errors caused by ribbon wrinkles formed in the ink ribbon during high-energy printing operation of high-speed printers can also be simultaneously prevented.

As a result of containing hollow particles in the intermediate layer, since thermal efficiency of the thermal head relative to the receiving layer is improved, printing density increases and image quality is improved. In addition, even if the receiving sheet is subjected to high pressure from the thermal head and transfer roller of the printer, since this stress can be absorbed within the receiving sheet, resistance to the formation of spikes and indentations in the surface of printed images on the receiving sheet caused by the transfer roller is improved.

The hollow particles used in the intermediate layer of the present invention are composed of a shell formed from a polymer material and one or more hollow sections surrounded thereby. Although there are no particular limitations on the process for producing the hollow particles, hollow particles can be selected from those indicated below produced as described in (a) and (b).
(a) Foamed hollow particles produced by causing thermal expansion of a thermoplastic polymer material containing a thermally expandable substance (also to be simply referred to as “foamed particles”).
(b) Microcapsular hollow particles obtained by using a polymer-forming material for the shell-forming material, using a volatile liquid for the void-forming material, and allowing the void-forming material to volatilize and disperse from the microcapsule produced by a microcapsule polymerization process.

In addition, particles composed of thermoplastic substance containing a thermally expandable substance (foamable particles) may be used as hollow particles in the non-foamed state, and foamed hollow particles may then be formed in a heating step during production of the receiving sheet, such as being foamed by heat in a drying step. However, if a thermoplastic substance containing a thermally expandable substance is foamed by heat in a production step of the receiving sheet as described above, it becomes difficult to foam the particles to a uniform particle diameter, and since particle diameter after thermal expansion cannot be precisely controlled, the surface of the intermediate layer ends up being highly irregular and has inferior smoothness. Since a receiving sheet having such an intermediate layer also has considerable surface irregularities in the surface of the receiving layer, the uniformity of thermally transferred images decreases thereby resulting in inferior image quality. Thus, foamed hollow particles produced in advance by causing thermal expansion of a thermoplastic substance containing a thermally expandable substance are used preferably in the present invention.

Foamed hollow particle produced by causing thermal expansion of a thermoplastic substance containing a thermally expandable substance is one prepared by, for example, thermally expanding a particle formed by using the thermoplastic material such as a homopolymer or copolymer of vinylidene chloride, vinyl chloride, acrylonitrile, methacrylonitrile, styrene or (meth)acrylic acid ester and so forth as the capsule shell (wall) material, to a predetermined particle diameter, for example by subjecting it to a preheating treatment, in which as the thermally expandable core substance, a volatile, low boiling point hydrocarbon such as n-butane, i-butane, pentane and/or neopentane is encapsulated.

In addition, since the foamed hollow particles produced by causing thermal expansion of a thermoplastic substance containing a thermally expandable substance as described above generally have a low specific gravity, an inorganic powder such as calcium carbonate, talc or titanium dioxide may be adhered to the surface of the foamed hollow particles by thermal bonding, for the purpose of further improving the handling and dispersibility thereof, and these foamed hollow particles in which the surfaces thereof are coated with an inorganic powder can also be used in the present invention.

The microcapsular hollow particles used in the present invention have hollow core sections formed by drying microcapsules comprising a hard resin of a polymer material such as a styrene-acrylic copolymer or melamine resin as the shell (wall) and a volatile liquid such as water in the core section, and then volatilizing and dispersing the water. These microcapsules can be prepared from a polymer-forming material (shell-forming material) and a volatile liquid (void-forming material) by a microcapsule-forming polymerization process.

The mean particle diameter of the hollow particles used in the present invention is 0.2 to 30 μm, preferably 0.5 to 10 μm, and more preferably 0.8 to 8 μm. In the case the mean particle diameter of the hollow particles is less than 0.2 μm, heat insulation and cushioning generally decrease due to the low volumetric hollow rate of the resulting hollow particles, thereby inhibiting the obtainment of adequate sensitivity and image quality improvement effects. In addition, if the mean particle diameter exceeds 30 μm, the smoothness of the resulting intermediate layer surface decreases, irregularities in the surface of the receiving sheet increase, the uniformity of thermally transferred images is inadequate, and image quality is inferior.

In addition, the maximum particle diameter of the hollow particles used in the present invention is preferably 100 μm or less, more preferably 50 μm or less and even more preferably 20 μm or less. If the maximum particle diameter of the hollow particles exceeds 100 μm, uneven printing density and white spots caused by coarse particles occur in thermally transferred images resulting in inferior image quality. In order to avoid the contamination of coarse particles having a maximum particle diameter in excess of 100 μm among the hollow particles, the set value of mean particle diameter can be adjusted to accommodate this during production of hollow particles that typically demonstrate a normal distribution. In addition, hollow particles can be obtained that are certainly free of coarse particles by providing a particle sizing step.

Furthermore, the particle diameter of the hollow particles described in the present specification can be measured using a conventional particle diameter measuring apparatus, and refers to the value measured using a laser diffraction type of particle size distribution analyzer (product name: SALD2000, Shimadzu Corporation).

The volumetric hollow rate of the hollow particles used in the present invention is preferably 40 to 95% and more preferably 75 to 95%. If the volumetric hollow rate is less than 40%, image quality may decrease. In addition, if the volumetric hollow rate exceeds 95%, the strength of the coating layer decreases and the hollow particles rupture during coating and drying, thereby leading to a decrease in surface smoothness.

Furthermore, the volumetric hollow rate of the hollow particles refers to the ratio of the volume of the hollow portion to the total particle volume. More specifically, it can be determined from the specific gravity of the hollow particles dispersed liquid comprising the hollow particles and a poor solvent, the mass fraction of the hollow particles in the dispersion liquid, the true specific gravity of the polymer resin that forms the shell (wall) of the hollow particles, and the specific gravity of the poor solvent.

In addition, the mean particle diameter and volumetric hollow rate of the hollow particles can also be determined from observations of cross-sectional micrographs of the surface of the hollow particles obtained with a scanning electron microscope (SEM) or transmission electron microscope (TEM).

The amount of hollow particles incorporated in the intermediate layer is preferably within the range of 30 to 75% by mass and more preferably within the range of 35 to 70% by mass as the ratio of the mass of the hollow particles to the mass of the total solid content of the entire intermediate layer. If the mass ratio of the hollow particles to the total solid content of the entire intermediate layer is less than 30% by mass, the heat insulation and cushioning of the intermediate layer become inadequate, thereby avoiding the obtainment of adequate sensitivity and image quality improving effects. In addition, if the mass ratio of the hollow particles exceeds 75% by mass, the coatability of the resulting coating for the intermediate layer decreases, the coated film strength becomes inadequate and the desired effects are unable to be obtained.

In order for the intermediate layer to demonstrate the desired heat insulation, cushioning and other performance, the film thickness of the intermediate layer is preferably 20 to 90 μm and more preferably 25 to 85 μm. If the film thickness of the intermediate layer is less than 20 μm, heat insulation and cushioning become inadequate, and the effects of improving sensitivity and image quality may be inadequate. In addition, if the film thickness exceeds 90 μm, heat insulation and cushioning effects become saturated, and in addition to being unable to obtain performance beyond that level, is also disadvantageous in terms of cost.

The hollow particles of the present invention are obtained by a production process such as suspension polymerizing a thermoplastic polymerizable material, i.e., a polymerizable monomer in the presence of a thermally expandable substance, i.e., a low boiling point organic solvent to produce particles in an unfoamed state, and then subjecting these unfoamed particles to treatment such as preheating to thermally expand to a predetermined particle diameter and to obtain foamed hollow particles.

The glass transition temperature (Tg) of the polymer material that forms the shells of the hollow particles of the present invention is preferably 75° C. or higher and more preferably 85 to 200° C. If the Tg is lower than 75° C., the hollow particles are deformed and destroyed by the heat in the drying step during production, thereby preventing the desired printing smoothness from being achieved, while also making it difficult to obtain the desired gloss by pressing against a molded surface having a constant surface roughness. On the other hand, in the case the Tg is excessively high, the amount of heat required for foaming becomes excessive, which is economically disadvantageous. Furthermore, the Tg of the hollow particles used in the present invention indicates the value measured using a differential scanning calorimeter (product name: SSC5200, Seiko Instruments Inc.) in accordance with the method defined in JIS K 7121.

The Tg of the polymer that forms the shells of the hollow particles can be adjusted by suitably selecting the polymerizable monomer and so forth used to produce the hollow particles. A nitrile monomer, non-nitrile monomer or crosslinking monomer, for example, is suitably used as necessary for the polymerizable monomer. Examples of nitrile monomers include acrylonitrile, methacrylonitrile, α-chloroacrylonitrile, α-ethoxyacrylonitrile, fumaronitrile and arbitrary mixtures thereof. Acrylonitrile and methacrylonitrile can be used preferably in the present invention for the purpose of increasing the Tg of the hollow particle shells since homopolymers thereof have a high Tg and superior heat resistance.

In addition, although examples of non-nitrile monomers include acrylic acid esters, methacrylic acid esters, styrene, vinyl acetate, vinyl chloride, vinylidene chloride, butadiene, vinyl pyridine, α-methylstyrene, chloroprene, neoprene and arbitrary mixtures thereof, among them, methyl acrylate, methyl methacrylate and ethyl methacrylate are preferable. Since non-nitrile monomers have a comparative low polymer Tg as compared with nitrile monomers, they have the effect of lowering the glass transition temperature of the resulting particles to within a desired range.

Moreover, a crosslinking monomer can also be used to produce the hollow particles. As a crosslinking monomers having two or more polymerizable double bonds therein, polyfunctional vinyl monomers and/or monomers having an internal olefin are preferable. Although specific examples include divinyl benzene, ethylene glycol dimethacrylate, triethylene glycol dimethacrylate, triacrylformal, trimethylol propane trimethacrylate, allyl methacrylate, 1,3-butyl glycol dimethacrylate and triallyl isocyanate, trifunctional crosslinking monomers such as triacrylformal and trimethylol propane trimethacrylate are preferable. The use of a crosslinking monomer has the effect of increasing the degree of crosslinking of the hollow particle shells, thereby improving heat resistance, chemical resistance and gas impenetrability. The wall material of the hollow particles of the present invention is prepared by suitably incorporating a polymerization initiator into the aforementioned components as necessary. Examples of polymerization initiators include azobisisobutyronitrile and benzoyl peroxide.

The softening point of the polymer material used in the shells of the hollow particles of the present invention is preferably 60° C. or higher and preferably 65 to 180° C. If the softening point is lower than 60° C., the hollow particles are deformed by the heat in the drying step during production. On the other hand, if the softening point exceeds 180° C., the amount of heat required for foaming becomes excessive, which is economically disadvantageous.

The intermediate layer of the present invention contains hollow particles and an adhesive resin. In consideration of the solvent resistance of the hollow particles, an aqueous coating is preferable for the intermediate layer coating of the present invention. Thus, although either an aqueous or organic solvent-based adhesive resin can be used, an aqueous resin is more preferable. There are no particular limitations on the adhesive resin used, and hydrophilic polymer resins such as polyvinyl alcohol-based resins, cellulose-based resins and derivatives thereof, casein and starch derivatives, for example, are used preferably from the viewpoints of film formability, heat resistance and flexibility. In addition, emulsions of various types of resins such as (meth)acrylic acid ester resins, styrene-butadiene copolymer resins, urethane resins, polyester resins and ethylene-vinyl acetate copolymer resins are used as aqueous resins having a low viscosity and high solid content. Furthermore, in terms of coated film strength, adhesiveness and coatability of the intermediate layer, the adhesive resin used in the intermediate layer preferably combines the use of the aforementioned hydrophilic polymer resins and an emulsion of various types of resins.

One or more types of various additives, such as antistatic agents, inorganic pigments, organic pigments, resin crosslinking agents, antifoaming agents, dispersants, organic dyes, release agents and lubricants, may be suitably selected and used as necessary in the intermediate layer.

(Barrier Layer)

A barrier layer may be provided as necessary on the intermediate layer in the present invention, and the receiving layer is provided on this barrier layer. This barrier layer is effective as a barrier for preventing destruction of the hollow particles caused by swelling and dissolution of the hollow particles of the intermediate layer attributable to penetration of organic solvent since the solvent of the receiving layer coating is generally an organic solvent such as toluene or methyl ethyl ketone. In addition, since the surface of the intermediate layer has irregularities caused by the hollow particles of the intermediate layer, the receiving layer provided thereon also has surface irregularities. These surface irregularities frequently causes white spots and uneven density in the resulting images, while also causing problems with image uniformity and resolution. In order to overcome this problem, provision of a barrier layer containing a flexible and elastic binder resin is effective for improving image quality.

A resin having superior film forming ability that prevents penetration of organic solvent and has elasticity and flexibility is used for the resin used in the barrier layer. More specifically, water-soluble polymer resins such as starch, modified starch, hydroxyethyl cellulose, methyl cellulose, carboxymethyl cellulose, gelatin, casein, gum Arabic, completely saponified polyvinyl alcohol, partially saponified polyvinyl alcohol, carboxy-modified polyvinyl alcohol, acetoacetyl group-modified polyvinyl alcohol, isobutylene-maleic anhydride copolymer salt, styrene-maleic anhydride copolymer salt, styrene-acrylic acid copolymer salt, ethylene-acrylic acid copolymer salt, urea resin, urethane resin, melamine resin and amide resin are used in the form of an aqueous solution. In addition, water-dispersible resins such as styrene-butadiene copolymer latex, acrylic acid ester resin latex, methacrylic acid ester copolymer resin latex, ethylene-vinyl acetate copolymer latex, polyester-polyurethane ionomer and polyether-polyurethane ionomer can also be used. Among the aforementioned resins, water-soluble polymer resins are used preferably. In addition, the aforementioned resins may be used alone or two or more types may be used in combination.

In addition, the aforementioned intermediate layer and the barrier layer may contain a white inorganic pigment such as calcium carbonate, titanium dioxide, zinc oxide, aluminum hydroxide, barium sulfate, silicon dioxide, aluminum oxide, talc, kaolin, diatomaceous earth or satin white as an inorganic pigment, or a fluorescent dye, to impart opacity and whiteness and improve the texture of the receiving sheet. An expandable, inorganic layered compound is preferably used for the inorganic pigment, and the use thereof not only prevents penetration of coating solvent, but also has the superior effect of preventing of thermally transferred dyed images. Specific examples of expandable, inorganic layered compounds include graphite, phosphate-based derivative compounds (such as zirconium phosphate compounds), chalcogen compounds, hydrotalcite compounds, lithium-aluminum composite oxides and clay-based minerals (such as synthetic mica, synthetic smectite, smectite group minerals, vermiculite group minerals and mica group minerals).

The barrier layer of the present invention is preferably formed using an aqueous coating liquid. The aqueous coating liquid preferably does not contain an excessive amount of organic solvent, including ketone-based solvents such as methyl ethyl ketone, ester-based solvents such as ethyl acetate, lower alcohol-based solvents such as methyl alcohol or ethyl alcohol, hydrocarbon-based solvents such as toluene or xylene or high boiling point, highly polar solvents such as DMF or cellosorb, in order to prevent swelling and dissolution of the hollow particles. The coating amount in solid content of the barrier layer is preferably within the range of 0.5 to 10 g/m² and more preferably within the range of 1 to 8 g/m². Incidentally, if the coating amount in solid content of the barrier layer is less than 0.5 g/m², the barrier layer may not be able to completely cover the surface of the intermediate layer, thereby causing the effect of preventing penetration of organic solvent to be inadequate. On the other hand, if the coating amount in solid content of the barrier layer exceeds 10 g/m², coating effects become saturated, which in addition to being uneconomical, results in excessive thickness of the barrier layer, thereby preventing adequate demonstration of heat insulating effects and cushioning by the intermediate layer, and leading to a decrease in image density.

(Receiving Layer)

In the receiving sheet of the present invention, the receiving layer is provided on the intermediate layer (with a barrier layer interposed there between as necessary). The receiving layer itself may be a known thermal dye transfer receiving layer. A resin having a high affinity for the dye that migrates from the ink ribbon, and thus a resin having satisfactory dye-dyeability, is used for the resin that forms the receiving layer. Examples of such dye-dyeable resins include thermoplastic resins such as polyester resin, polycarbonate resin, polyvinyl chloride resin, vinyl chloride-vinyl acetate copolymer resin, polyvinyl acetal resin, polyvinyl butyral resin, polystyrene resin, polyacrylic acid ester resin, cellulose acetate butyrate and other cellulose derivative-based resins and polyamide resin, and active energy beam-curable resins. These resins preferably have a functional group having reactivity for the crosslinking agent used (such as a hydroxyl group, amino group, carboxyl group or epoxy group).

In addition, one or more types of additives such as a crosslinking agent, release agent or lubricant is preferably incorporated in the receiving layer to prevent thermal bonding between the receiving layer and ink ribbon caused by heating with the thermal head during printing. In addition, one or more types of additives such as a fluorescent dye, plasticizer, antioxidant, pigment, filler, ultraviolet absorber or antistatic agent may be added to the receiving layer as necessary. These additives may be mixed with the components forming the receiving layer before coating, or they may be coated over and/or under the receiving layer in the form of a coated layer separate from the receiving layer.

The coating amount in solid content of the receiving layer is preferably within the range of 1 to 12 g/m² and preferably within the range of 3 to 10 g/m². Incidentally, if the coating amount in solid content of the receiving layer is less than 1 g/m², the receiving layer may not be able to completely cover the surface of the barrier layer, image quality may decrease, and sticking problems may occur in which the receiving layer and ink ribbon become adhered by heat from the thermal head. On the other hand, if the coating amount in solid content exceeds 12 g/m², the effects thereof become saturated, which in addition to being uneconomical, causes insufficient coated film strength of the receiving layer, or as a result of the coated film thickness becoming excessive, the heat insulating effects of the sheet-form substrate are unable to be adequately demonstrated, thereby resulting in a decrease in image density.

(Back Layer)

The receiving sheet of the present invention may also be provided with a back layer on the back of the sheet-form substrate (opposite side from the side on which the receiving layer is provided). The back layer consists mainly of a resin that is effective as an adhesive, and may contain, for example, a crosslinking agent, conducting agent, sticking preventive agent or inorganic and/or organic pigment.

A resin for forming the back layer that is effective as an adhesive is used for the back layer of the present invention. This resin is effective for improving adhesive strength between the back layer and sheet-form substrate, improving printer transportability of the receiving sheet, preventing scratching of the surface of the receiving layer and preventing migration of dye to the back surface in contact with the surface of the receiving layer. Examples of such resins that can be used include acrylic resin, epoxy resin, polyester resin, phenol resin, alkyd resin, urethane resin, melamine resin, polyvinyl acetal resin and cured reaction products of these resins.

A crosslinking agent such as a polyisocyanate compound or epoxy compound may be suitably incorporated in a back layer coating to improve adhesiveness between the sheet-form substrate and the back layer. In general, the blending ratio is preferably about 1 to 30% by mass based on the total solid content of the back layer.

A conducting agent such as an electrically conductive polymer or electrically conductive inorganic pigment may be added to the back layer of the present invention to improve printer transportability and prevent static electricity. Examples of electrically conductive polymers include cationic, anionic and nonionic electrically conductive polymer compounds. Examples of cationic polymer compounds include polyethyleneimine, acrylic polymers containing a cationic monomer, cation-modified acrylamide polymers and cationic starch. In addition, examples of anionic polymer compounds include polyacrylates, polystyrene sulfonates and styrene-maleic acid copolymers. In general, the blending ratio of the conducting agent is preferably about 5 to 50% by mass based on the total solid content of the back layer.

In addition, examples of electrically conductive inorganic pigment include compound semiconductor pigments such as an oxide and/or sulfide and inorganic pigments coated with the aforementioned compound semiconductor pigments. Examples of compound semiconductor pigments include cuprous oxide, zinc oxide, zinc sulfide and silicon carbide. In addition, examples of inorganic pigments coated with a compound semiconductor include titanium oxide and potassium titanate coated with a compound semiconductor, and electrically conductive inorganic pigments in the shape of needles or spheres are commercially available.

A friction coefficient adjuster in the form of an organic or inorganic filler can also be incorporated in the back layer of the present invention as necessary. Examples of organic fillers that can be used include Nylon filler, cellulose filler, urea resin filler, styrene resin filler and acrylic resin filler. Examples of inorganic fillers that can be used include silica, barium sulfate, kaolin, clay, talc, calcium bicarbonate, precipitated calcium carbonate, titanium oxide and zinc oxide. In the case of a Nylon filler, for example, the mean particle diameter is preferably about 1 to 25 μm and, although it depends on the mean particle diameter, the incorporated amount is preferably about 2 to 30% by mass based on the total solid content of the back layer.

The back layer can also contain a sticking preventive such as a lubricant or release agent as necessary. Examples of sticking preventives include silicone-based compounds such as non-modified and modified silicone oils, silicone block copolymers and silicone rubber, phosphoric acid ester compounds, fatty acid ester compounds and fluorine compounds. In addition, conventionally known antifoaming agents, dispersants, colored pigments, fluorescent dyes, fluorescent pigments and ultraviolet absorbers may also be suitably selected and used.

The coating amount in solid content of the back layer is preferably within the range of 0.3 to 10 g/m² and more preferably within the range of 1 to 8 g/m². If the coating amount in solid content of the back layer is less than 0.3 g/m², scratching prevention when the receiving sheet is rubbed is not adequately demonstrated, coating defects occur and the electrical resistance of the surface may increase. On the other hand, if the coating amount in solid content exceeds 10 g/m², the effects become saturated making this uneconomical.

(Primer Coating Layer)

In the receiving sheet of the present invention, a primer coating layer consisting mainly of a polymer resin may be provided between the substrate and the intermediate layer. As a result of providing this primer coating layer, there is no penetration of coating liquid into the substrate even an intermediate layer coating liquid is coated onto the substrate, and the intermediate layer can be formed to a desired thickness. Examples of polymer resins used in this primer coating layer include acrylic resin, polyurethane resin, polyester resin, polyolefin resin and modified resins thereof.

In the case of using, for example, a paper base material for the substrate in the present invention, if a primer coating layer comprised of an aqueous coating liquid is coated thereon, wrinkles and twisting may occur in the paper base material which have a detrimental effect on texture and printing adaptability due to uneven moisture absorption by the surface of the paper base material. Thus, in such cases, it is preferable to use a coating liquid for the primer coating layer in which a polymer resin is dissolved or dispersed in an organic solvent instead of an aqueous coating liquid. Examples of organic solvents that can be used include conventional organic solvents such as toluene, methyl ethyl ketone, isopropyl alcohol and ethyl acetate.

In addition, a white inorganic pigment such as titanium dioxide, calcium carbonate or barium sulfate may be added to the primer coating layer to improve the coatability of the primer coating layer coating liquid itself, improve adhesion between the substrate and intermediate layer, and improve the whiteness of the receiving sheet. The coating amount in solid content of the primer coating layer is preferably within the range of 1 to 20 g/m². If the coating amount in solid content is less than 1 g/m², the effects of the primer coating layer may not be able to be obtained, while if the coating amount in solid content exceeds 20 g/m², the effects of the primer coating layer become saturated, thereby making this uneconomical, while also causing the receiving sheet to lose the texture of paper.

An example of a production process of the receiving sheet of the present invention is carried out with the steps indicated below.

After coating (a) an intermediate layer coating liquid, containing hollow particles having a mean particle diameter of 0.2 to 30 μm and volumetric hollow rate of 40 to 95%, onto at least one side of a sheet-form substrate and drying to provide an intermediate layer, and/or after providing (b) an image receiving layer on this intermediate layer, by (c) carrying out a smoothing treatment step by passing the sheet between the nip sections of a pair of rollers comprising a heating roller and a press roller, the printing smoothness (Rp value) of the surface of the receiving sheet as measured 10 msec after the start of pressurization at a printing pressure of 0.1 MPa using a microtopograph can be adjusted to 1.5 μm or less, and the 20° gloss based on JIS Z 8741 can be adjusted to 80 or less.

More preferably, after the step (a) for providing the intermediate layer, the barrier layer is provided on the intermediate layer, and the receiving layer is formed on the barrier layer. In addition, the production process may also have a step in which the back layer is provided on the side of the sheet-form substrate not provided with the receiving layer.

In the present invention, the intermediate layer, barrier layer, receiving layer, back layer and other coating layers can be formed in accordance with ordinary methods by preparing coating solutions containing each of the required components, coating onto the required side of the sheet-form substrate using a known coater such as a bar coater, gravure coater, comma coater, blade coater, air knife coater, gate roll coater, die coater, curtain coater, lip coater or slide bead coater followed by drying and heat-curing as necessary.

The printing smoothness Rp of the receiving layer surface of the receiving sheet of the present invention is 1.5 μm or less, the gloss on the side of the receiving layer is 80 or less. Although the following indicates examples of methods for controlling the characteristics of the receiving layer surface in this manner, the present invention is not limited to these methods. In addition, these methods can be suitably combined as necessary.

(1) In the production process of a sheet-form substrate composed mainly of cellulose pulp, surface irregularities in the substrate are reduced by using a sizing agent such as a higher organic ketene dimer, substituted cyclic dicarboxylic acid anhydride or epoxidated higher fatty amide to improve size and prevent bleeding into the substrate during coating of an intermediate layer. The amount of sizing agent added to the raw paper is preferably within the range of 0.1 to 2.0% by mass based on the absolute dry mass of the pulp.

### (2) The smoothness of the sheet-form substrate is improved by forming a coating layer consisting mainly of a pigment, resin and so forth on at least one side of the sheet-form substrate consisting mainly of cellulose pulp.

(3) An organic pigment such as a Nylon filler, cellulose filler, urea resin filler, styrene resin filler or acrylic resin filler, or an inorganic pigment such as silica, barium sulfate, kaolin, clay, talc, calcium bicarbonate, precipitated calcium carbonate, titanium oxide or zinc oxide, is contained in at least one layer of the intermediate layer, the barrier layer and the receiving layer. The mean particle diameter of the pigment is preferably 0.1 to 10 μm, and the incorporated amount is preferably 0.1 to 30% by mass based on the total solid content of the layer.
(4) At least one layer of the intermediate layer, the barrier layer and the receiving layer is formed in accordance with the ordinary methods as described above by suitably selecting a coating method for forming the coating layer using various types of coaters, or a transfer method in which a coating layer is formed on the surface of a plastic film and so forth followed by transferring to a base material such as a sheet-form substrate.
(5) Smoothing treatment is carried out on at least one layer of the sheet-form substrate consisting mainly of cellulose pulp, the intermediate layer, the barrier layer, the receiving layer and the like by suitably using a calendering apparatus commonly used in the papermaking industry, such as a super calender, soft calender, gross calender, machine calender or clearance calender.
(6) Smoothing treatment is carried out by pressing at least one layer of the sheet-form substrate consisting mainly of cellulose pulp, the intermediate layer, the barrier layer, the receiving layer and the like, against a metal sheet or metal drum subjected to surface treatment such as chrome plating as necessary, or a plastic film rendered releasable with a higher fatty acid and so forth.

The preferable nip pressure of the smoothing treatment is preferably 0.2 to 150 MPa, more preferably 0.3 to 100 MPa and particularly preferably 2 to 50 MPa. In addition, the retention time of the receiving sheet in the nip unit, although considerably subjected to the effects of the hardness of the press roller, the calender line pressure, the treatment speed and so forth, is preferably within the range of 5 to 500 msec.

The temperature of the heating roller is preferably within the range of room temperature to the melting point of the binder contained in the coating layer on which the smoothing treatment is carried out, and is, for example, 20 to 150° C. and more preferably 30 to 120° C. In addition, the surface roughness of the heating roller in terms of the centerline average roughness (Ra) based on JIS B 0601 is preferably within the range of 0.01 to 5 μm and more preferably 0.02 to 1 μm.

In addition, the temperature during molded surface treatment is preferably 20 to 150° C., and the surface roughness (Ra) of the molded surface is preferably 0.01 to 1.0 μm. If the surface roughness (Ra) is less than 0.01 μm, the gloss of the resulting products becomes excessively high resulting in the occurrence of gloss unevenness. On the other hand, if Ra exceeds 1.0 μm, the printing smoothness Rp of the resulting products increases resulting in poor image uniformity.

A metal sheet, metal drum or plastic film and so forth having satisfactory dimensional stability and a highly smooth surface is preferably used for the molded surface. In addition, a higher fatty acid-based release agent such as calcium stearate or zinc stearate, a polyethylene-based release agent such as a polyethylene glycol emulsion, or a release agent such as wax or silicone may be coated onto the molded surface as necessary to facilitate separation of each layer from the molded surface.

### EXAMPLES

Although the following provides a detailed explanation of the present invention through the following examples, the scope of the present invention is not limited by these examples. Furthermore, in the following examples, the terms “%” and “parts” indicate “% by mass” and “parts by mass”, respectively, in all cases unless specifically indicated otherwise, and refer to the solid content except with respect to solvents.

### Example 1

[Formation of Back Layer]

Using art paper having a thickness of 150 μm (product name: OK Kinfuji, 174.4 g/m², Oji Paper Co., Ltd.) for the sheet-form substrate, a back layer coating liquid 1 having the composition shown below was coated onto one side thereof to a coating amount of 3 g/m² in solid content after drying, followed by drying to form a back layer.

Back Layer Coating Liquid 1

| | |
|---|---|
| Polyvinyl acetal resin (product name: | 40 parts |
| Eslec KX-1, Sekisui Chemical Co., Ltd.) | |
| Polyacrylic acid ester resin (product | 20 parts |
| name: Jurimer AT613, Nihon Junyaku Co., Ltd.) | |
| Nylon resin particles (product name: | 10 parts |
| MW330, Shinto Paint Co., Ltd.) | |
| Zinc stearate (product name: Z-7-30, | 10 parts |
| Chukyo Yushi Co., Ltd.) | |
| Cationic conductive resin (product name: | 20 parts |
| Chemistat 9800, Sanyo Chemical | |
| Industries Ltd.) | |
| Water/isopropyl alcohol mixture (mass | 400 parts |
| ratio = 2/3) | |

[Formation of Intermediate Layer]

Next, an intermediate layer coating liquid 1 having the composition shown below was coated onto the opposite side of the sheet-form substrate provided with the back layer to a film thickness of 43 μm after drying followed by drying to form an intermediate layer, after which calendering treatment (roller surface temperature: 80° C., nip pressure: 2.5 MPa) was further carried out to smooth the surface thereof.

Intermediate Layer Coating Liquid 1

| | |
|---|---|
| Polyvinylidene chloride-based foamed | 35 parts |
| hollow particles (volumetric hollow | |
| rate: 93%, mean particle diameter: 4 μm, | |
| maximum particle diameter: 20 μm, Tg of | |
| polymer material forming shells: 80° C., | |
| softening point: 67° C.) | |
| Polyvinyl alcohol (product name: PVA205, | 15 parts |
| Kuraray Co., Ltd.) | |
| Styrene-butadiene latex (product name: | 50 parts |
| PT1004, Nippon Zeon Corp.) | |
| Water | 200 parts |

[Production of Receiving Sheet]

A barrier layer coating liquid 1 having the composition indicated below was further coated onto the intermediate layer to a coating amount of 2 g/m² in solid content, followed by drying to form a barrier layer, and a receiving layer coating liquid 1 having the composition indicated below was further coated onto this barrier layer to a coating amount of 5 g/m² in solid content, followed by drying and curing for 48 hours at 50° C. to form a receiving layer and produce a receiving sheet.

Moreover, following formation of the receiving layer, molding treatment was carried out by pressing the receiving layer side against a metal roller having a temperature of 78° C. and a surface roughness (Ra) of 0.03 μm at a pressure of 10 MPa.

Barrier Layer Coating Liquid 1

| | |
|---|---|
| Polyvinyl alcohol (product name: PVA117, | 100 parts |
| Kuraray Co., Ltd.) | |
| Water | 1000 parts |

Receiving Layer Coating Liquid 1

| | |
|---|---|
| Polyester resin (product name: Vylon 200 | 100 parts |
| Toyobo Co., Ltd.) | |
| Silicone oil (product name: KF393, | 3 parts |
| Shin-Etsu Chemical Co., Ltd.) | |
| Polyisocyanate (product name: Takenate | 5 parts |
| D-140N, Mitsui Takeda Chemicals, Inc.) | |
| Toluene/methyl ethyl ketone mixture | 400 parts |
| (mass ratio: 1/1) | |

### Example 2

A receiving sheet was produced in the same manner as Example 1 with the exception of using the receiving layer coating liquid 2 having the composition indicated below for forming the receiving layer.

Receiving Layer Coating Liquid 2

| | |
|---|---|
| Polyester resin (product name: Vylon 200, | 97 parts |
| Toyobo Co., Ltd.) | |
| Organic filler (product name: Epostar | 3 parts |
| MA1001, Nippon Shokubai Co., Ltd., | |
| particle diameter: 1 μm) | |
| Polyisocyanate (product name: Takenate | 5 parts |
| D-140N, Mitsui Takeda Chemicals, Inc.) | |
| Toluene/methyl ethyl ketone mixture | 400 parts |
| (mass ratio: 1/1) | |

### Example 3

A receiving sheet was produced in the same manner as Example 1 with the exception of molding the receiving sheet by pressing the receiving layer side against a metal roller having a surface roughness (Ra) of 0.06 μm at a pressure of 15 MPa following formation of the receiving layer.

### Example 4

A receiving sheet was produced in the same manner as Example 1 with the exception of coating the intermediate layer coating liquid 2 having the composition indicated below to a film thickness after drying of 74 μm followed by drying to form an intermediate layer.

Intermediate Layer Coating Liquid 2

| | |
|---|---|
| Foamed hollow particles comprised of a | 45 parts |
| copolymer consisting mainly of acrylonitrile | |
| and methacrylonitrile (volumetric hollow | |
| rate: 43%, mean particle diameter: 3.3 μm, | |
| Tg of polymer material forming shells: | |
| 145° C., softening point: 122° C.) | |
| Polyvinyl alcohol (product name: PVA205 | 10 parts |
| Kuraray Co., Ltd.) | |
| Styrene-butadiene latex (product name: | 45 parts |
| PT1004, Nippon Zeon Corp.) | |
| Water | 250 parts |

### Comparative Example 1

A receiving sheet was produced in the same manner as Example 1 with the exception of omitting smoothing of the surface of the intermediate layer when forming the intermediate layer.

### Comparative Example 2

A receiving sheet was produced in the same manner as Example 1 with the exception of using the receiving layer coating liquid 3 having the composition indicated below for forming the receiving layer. However, the surface of the receiving layer was not molded.

Receiving Layer Coating Liquid 3

| | |
|---|---|
| Polyester resin (product name: Vylon 200 | 97 parts |
| Toyobo Co., Ltd.) | |
| Organic filler (product name: Orgasol | 3 parts |
| particle diameter: 10 μm) | |
| Polyisocyanate (product name: Takenate | 5 parts |
| D-140N, Mitsui Takeda Chemicals, Inc.) | |
| Toluene/methyl ethyl ketone mixture | 400 parts |
| (mass ratio: 1/1) | |

Evaluation

Each of the receiving sheets obtained in the examples and comparative examples described above were evaluated according to the methods described below. The results obtained are shown in Table 1.

[Printing Smoothness]

Printing smoothness (Rp value) was measured 10 msec after the start of pressurization at a printing pressure of 0.10 MPa using a printing pressure tester (Microtopograph, Toyo Seiki Seisakusho Co., Ltd.).

[Gloss]

White paper gloss of the receiving layer side was measured at an incident angle of 20° using a gloss tester (Toyo Seiki Seisakusho Co., Ltd.).

[Compressive Elastic Modulus]

Compressive elastic modulus of the receiving sheet was measured in accordance with JIS K 7220 (Testing Method for Compressive Properties of Rigid Cellular Plastics). However, the height of the test piece was set to the thickness of the test receiving sheet (approx. 200 μm). In addition, the compression rate was 20 μm/min.

[Printing Quality] (Printing Density, Image Uniformity)

With use of each of the receiving sheets obtained in the examples and comparative examples as well as of a commercially available thermal transfer video printer (product name: UP-DR100, Sony Corp.), predetermined images were thermally transferred to the receiving sheets, thereby halftone single color and multiple color images were printed in each color. This was conducted by sequentially contacting each ink layer of an ink sheet provided with ink layers respectively containing yellow, magenta or cyan sublimation dye along with a binder on a 6 μm thick polyester film with each receiving sheet, and then applying stepwise-controlled heat with a thermal head.

(Printing Density)

The reflection density of each of the resulting recorded images was measured using a Macbeth reflection densitometer (product name: RD-914, Kollmorgen Ltd.). The density of the high-contrast portion corresponding to the 15th step from the lowest printing energy is indicated as the printing density in Table 1.

(Image Uniformity)

The presence of density unevenness and white spots at a portion having contrast equivalent to an optical density (black) of 0.3 was evaluated visually as an indicator of recorded image uniformity.

Superior evaluation results were indicated with “superior”, good evaluation results were indicated with “good”, slight presence of density unevenness and white spots were indicated with “acceptable”, and prominent density unevenness and white spot defects were indicated with “poor”.

[Evaluation of Gloss Unevenness]

Each of the unrecorded receiving sheets obtained in the examples and comparative examples were stacked and superimposed on each other so that the back side made contact with the side of the receiving layer followed by subjecting to a load of 500 g/cm², and visually observing the appearance of gloss unevenness occurring due to scratches in the receiving layer side.

The absence of hardly any gloss unevenness was indicated with “good”, while prominent gloss unevenness was indicated with “poor”.

TABLE 1

| | Printing | | | | | | |
|---|---|---|---|---|---|---|---|
| | smoothness | | Compressive | | | | |
| | Rp | | elastic | Hollow | | | Gloss |
| | value | 20° | modulus | particle | Printing | Image | unevenness |
| | (μm) | gloss | (MPa) | Tg (° C.) | density | uniformity | appearance |
| Ex. 1 | 0.5 | 67 | 25 | 80 | 2.01 | Superior | Good |
| Ex. 2 | 1.1 | 42 | 28 | 80 | 1.95 | Acceptable | Good |
| Ex. 3 | 0.7 | 55 | 26 | 80 | 2.15 | Good | Good |
| Ex. 4 | 1.2 | 75 | 31 | 145 | 1.95 | Good | Good |
| Comp. | 0.2 | 90 | 21 | 80 | 1.78 | Superior | Poor |
| Ex. 1 | | | | | | | |
| Comp. | 3.0 | 24 | 32 | 80 | 1.65 | Poor | Good |
| Ex. 2 | | | | | | | |

As is clear from Table 1, the receiving sheets obtained in each of the examples of the present invention demonstrated good printing density, image uniformity and other aspects of printing quality, were free of gloss unevenness and were suitable for practical use. On the other hand, the receiving sheet of Comparative Example 1 exhibited insufficient printing density and prominent gloss unevenness, while the receiving sheet of Comparative Example 2 exhibited poor printing quality and inferior product value.

### INDUSTRIAL APPLICABILITY

The receiving sheet of the present invention enables high-sensitivity and high-density recording, offers improved density unevenness and white spots, yields extremely high image quality, is resistant to the occurrence of gloss unevenness caused by microscratches, and is suitable for the formation of images with a thermal dye transfer printer.

1. A thermal transfer receiving sheet having laminated, on at least one side of its sheet-form substrate, an intermediate layer and an image receiving layer in this order, wherein said intermediate layer comprises hollow particles, and the mean particle diameter of the hollow particles is 0.2 to 30 μm, the volumetric hollow rate is 40 to 95%, the printing smoothness (Rp value) of the surface of the image receiving layer as determined 10 msec after the start of pressurization at a printing pressure of 0.1 MPa using a microtopograph is 1.5 μm or less, and the 20° gloss in accordance with JIS Z 8741 is 80 or less.

2. The thermal transfer receiving sheet according to claim 1, wherein the thickness of the intermediate layer is 20 to 90 μm.

3. The thermal transfer receiving sheet according to claim 2, wherein the compressive elastic modulus of the thermal transfer receiving sheet in accordance with JIS K 7220 is 35 MPa or less.

4. The thermal transfer receiving sheet according to claim 3, wherein the surface of the image receiving layer is formed by pressing against a molded surface having a centerline average roughness (Ra) of 0.01 to 1.0 μm.

5. The thermal transfer receiving sheet according to claim 4, wherein the surface of the image receiving layer is formed by pressing against a molded surface at a pressure of 0.2 to 150 MPa.

6. The thermal transfer receiving sheet according to claim 2, wherein the intermediate layer contains hollow particles in which shells are formed from a polymer material having a glass transition temperature of 75° C. or higher.

7. The thermal transfer receiving sheet according to claim 1, wherein the compressive elastic modulus of the thermal transfer receiving sheet in accordance with JIS K 7220 is 35 MPa or less.

8. The thermal transfer receiving sheet according to claim 7, wherein the surface of the image receiving layer is formed by pressing against a molded surface having a centerline average roughness (Ra) of 0.01 to 1.0 μm.

9. The thermal transfer receiving sheet according to claim 1, wherein the surface of the image receiving layer is formed by pressing against a molded surface having a centerline average roughness (Ra) of 0.01 to 1.0 μm.

10. The thermal transfer receiving sheet according to claim 2, wherein the surface of the image receiving layer is formed by pressing against a molded surface having a centerline average roughness (Ra) of 0.01 to 1.0 μm.

11. The thermal transfer receiving sheet according to claim 10, wherein the surface of the image receiving layer is formed by pressing against a molded surface at a pressure of 0.2 to 150 MPa.

12. The thermal transfer receiving sheet according to claim 8, wherein the surface of the image receiving layer is formed by pressing against a molded surface at a pressure of 0.2 to 150 Mpa.

13. The thermal transfer receiving sheet according to claim 9, wherein the surface of the image receiving layer is formed by pressing against a molded surface at a pressure of 0.2 to 150 Mpa.

14. The thermal transfer receiving sheet according to claim 1, wherein the intermediate layer contains hollow particles in which shells are formed from a polymer material having a glass transition temperature of 75° C. or higher.
